(19) United States
(12) Patent Application Publication
(10) Pub. No.: US 2014/0246824 A1
(43) Pub. Date: Sep. 4, 2014

(54) Vise with Bi-directional Arms

(71) Applicants: Andrew P. Fiegener, Claremore, OK (US); Sarah R. Fiegener, Claremore, OK (US)

(72) Inventors: Andrew P. Fiegener, Claremore, OK (US); Sarah R. Fiegener, Claremore, OK (US)

(21) Appl. No.: 14/186,570

(22) Filed: Feb. 21, 2014

Related U.S. Application Data
(60) Provisional application No. 61/771,818, filed on Mar. 2, 2013.

(51) Int. Cl. B25B 1/24

(52) U.S. Cl. CPC B25B 1/2478
USPC 269/265

(57) ABSTRACT

Disclosed is a vise allows the user to hold an object with two support locations instead of one, and optionally offer interchangeable multi-purpose vise heads to accomplish a variety of different tasks. It is a vise having a base on which is attached a fixed mounting member and a movable mounting member, having attached thereon clamping arm supports that are positioned perpendicular to the movement of the movable mounting member and having at least two clamping arms on at least one mounting support and means for moving the fixed and movable mounting members toward and away from each other.

### CROSS REFERENCE TO RELATED APPLICATIONS

This application claims benefit of Provisional Application Ser. No. 61/771,818 filed Mar. 2, 2013. The contents and disclosures this application is incorporated herein by reference in its entirety for all purposes.

### BACKGROUND

1. Field of Invention

This invention relates to mechanical vises and the field of work piece holding. The newly invented vise allows the user to hold an object with two support locations instead of one, and optionally offer interchangeable multi-purpose vise heads to accomplish a variety of different tasks.

2. Background

Mechanic vises are used primarily in outdoor workplace and shop environments, used under extreme weather conditions and without routine maintenance. Thus, vises should be rugged, versatile and highly reliable. A vise should also be simple to operate, having reliable working parts and a straightforward means of operation. A vise is most generally a tool used for work holding, and all the many aspects that go with work holding, but can and often is used as a striking surface, a bending and cutting device, a maintenance and repair tool, etc. Today's standard vise operates with a set of clamping jaws moved inwards/outwards by an acme threaded screw, nut, and/or lever combination. The majorities of vises also have a rotating or swivel base that allows it to be rotated to any desired working angle. This is a valuable feature when a piece must be positioned just right for an operation to be performed. Vises are traditionally used for cutting/working applications, where the user requires increased stability to perform a desired task. So if Person “A” wanted to cut a piece of pipe into two pieces, a traditional vise would be used to hold one end of the pipe while a saw or other cutting apparatus would then be applied to the middle of the pipe and the opposite end would then fall once the cut was complete. This is preferred over other options of holding, such as using hands or hand operated clamps.

Although mechanic vises of today offer great functionality over holding a work piece by hand or with a set of clamps, the current products have seen little improvements over time to better accommodate the end user's needs. Most vises today offer small throat depth below the clamping heads so that any piece of awkward shape becomes very difficult to clamp below the jaws and in many cases can't be clamped, forcing the user to seek other options. Another drawback of conventional vises is that there are no specialized attachments that may be used to bend a piece of sheet-metal, or shape a piece of tubing, etc. Additionally, when cutting material, once a piece is cut the wayward end will remain unsupported and fall to the floor. This can be a safety hazard in the case of heavy walled pipe or other piece having a large mass. The present invention solves many of those problems.

### SUMMARY

The object of the present invention is to take what is a simple, reliable device and add features and benefits that have never been seen, and doing so without compromising operation and reliability. In broad aspect it is a vise having a base on which is attached a fixed mounting member and a movable mounting member, having attached thereon clamping arm supports that are positioned perpendicular to the movement of the movable mounting member and having at least two clamping arms on at least one mounting support and means for moving the fixed and movable mounting members toward and away from each other. In one aspect the clamping arms are removably attached and movable along a support track that is attached to a mounting base. In another aspect, the clamping arms have replaceable heads.

### DESCRIPTION OF THE DRAWINGS

In the accompanying drawings, in which one of various possible embodiments of the invention is illustrated, corresponding reference characters refer to corresponding parts throughout the several views of the drawings in which:

FIG. 1 is a perspective view of an embodiment of the invention.

2

FIG. 2 is a side view of an embodiment of the invention

FIG. 3 is a front view of an embodiment of the invention.

FIG. 4 is a top or downward facing view of an embodiment of the invention.

FIG. 5 is an exploded perspective view of an embodiment of the invention.

FIG. 6 is a perspective view of interchangeable clamping heads of an embodiment of the invention.

FIG. 7 is also perspective view of interchangeable clamping heads of an embodiment of the invention.

FIG. 8 is also perspective view of interchangeable clamping heads of an embodiment of the invention.

FIG. 9 is also perspective view of interchangeable clamping heads of an embodiment of the invention.

FIG. 10 is a perspective view of embodiments od clamping arm of an embodiment of the invention.

### DETAILED DESCRIPTION

In broad aspect the present invention is, in its embodiments, a vise base and mounting members with bi-directional clamping arms (jaws) and optionally with removable clamping heads attached to the arms. It is a vise having a base on which is attached a fixed mounting member and a movable mounting member, each clamping arms attached and means for positioning the mounting members toward and away from each other.

Conventional vise clamping arms move in only one direction, are very limited on space below the jaw, and have an antiquated design. Vise and mechanics vise as the term is used herein means any of the clamping tools commonly referred to as vises including engineer's vises, mechanic's vises, carpenter's vises, woodworking vises, hobby vises, jeweler's vise, bench vises, etc.

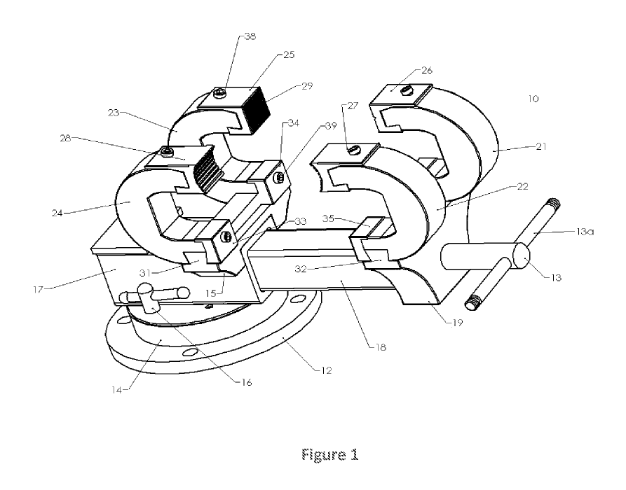

Embodiments of the invention are illustrated in the drawings. Referring to FIG. 1 that is an illustration of one embodiment of the invention, a vise assembly 10 has a swivel support base 12 and 14 with a handle 16 to adjust the position of the base. Disposed on the base is fixed mounting member 17 into which mount slide 18 may move by action of a threaded rod and bolt by which means it is attached to rod 13. Item 19 is a clamping arm mount attached to 18 that is movable toward and away from mount 17 along the track 18. Items 21, 22, 23 and 24 are clamping arms that can be positioned along clamping arm supports 15 and 19 having an illustrative configuration of 31 and 32. There is shown the preferred configuration that has at least two clamping arms on each support. However, in one aspect there may be two arms on one support and only one arm on the other. This arrangement will have advantages in some specialized situations. The arm support is configured to allow the clamping arms to move perpendicular to the direction of the movable mounting member. The clamping arms can be positioned along the arm supports to adjust the separation space between the separate clamping arms and locking means to secure the arms in place. The arms may be secured to the arm support in various ways as will be explained in more detail below.

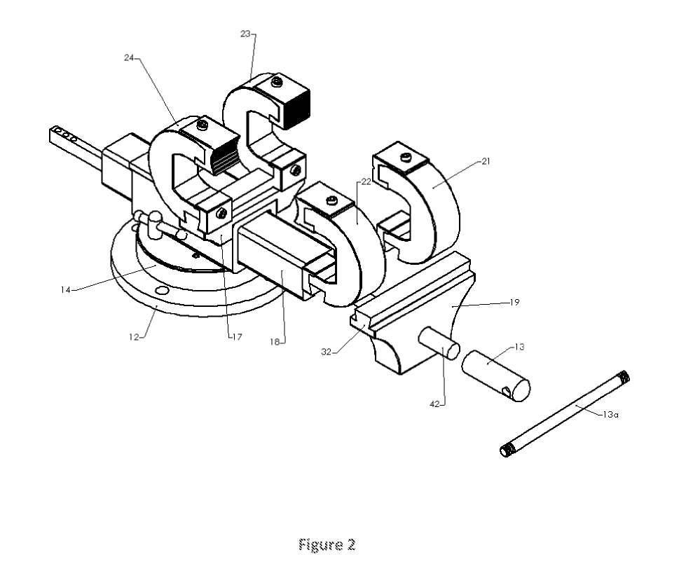

The clamping arms are preferably substantially configured into a C shaped as shown to allow open space for positioning awkward work pieces but other configurations are also suitable, especially those configured for special application. Items 26, 27, 28 and 29 are interchangeable clamping heads that are adapted to be removable but securely attached to the clamping arms, as by the configuration shown (or any other suitable configuration). They are secured by set screws 38. The face (the part of the head that faces toward the opposite clamping arm head) of the heads shown is patterned to enable a more secure hold. FIG. 2 is a view similar to FIG. 1 showing more detail of the movable mounting member 19 and the mounting configuration 32. Item 42 is the threaded rod that engages a threaded bolt that when rotated moves the mounting member 19 towards or away from the fixed mounting member 17.

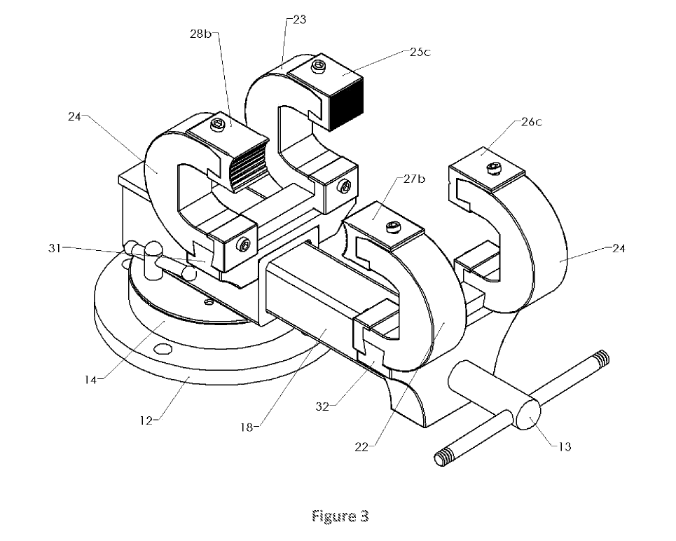

FIG. 3 shows the same embodiment as FIGS. 1-2 but with different clamping arm heads, 25c, 26c, 27b and 28b.

FIG. 4 shows a somewhat different configuration of the fixed and movable mounting members and more particularly shows different configurations of the clamping arm heads 44, 45, 46 and 47.

In FIG. 4 the mounting members 51 and 52 are different from those of FIGS. 1 and 2 and there is not shown an attachment device as 33 and 35 in FIGS. 1 and 2. One embodiment is the dove-tail notch or V-notch in the heads, 46 and 47. The positioning means 58 is, as in FIGS. 1 and 2, a threaded rod that fits into a fixed female threaded bolt so that when rotated the parts will come together or separate depending on the rotation. The fixed threaded bolt member may be located in the stationary mounting member and the threaded rod will push the movable mounting member or it may be located in the movable member with the rod attached to the fixed mounting member.

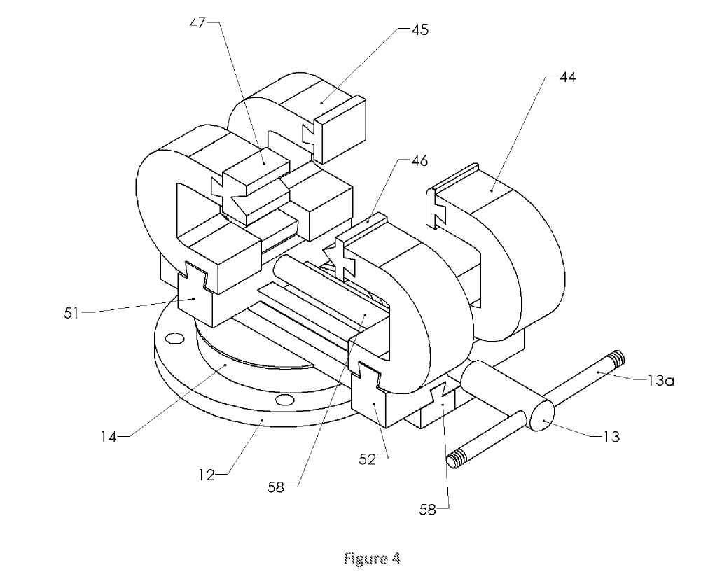

FIG. 5 shows a view of the same embodiment as FIGS. 1 and 2 with more detail of the way the heads 25-28 are attached to the clamping arms, 21-24.

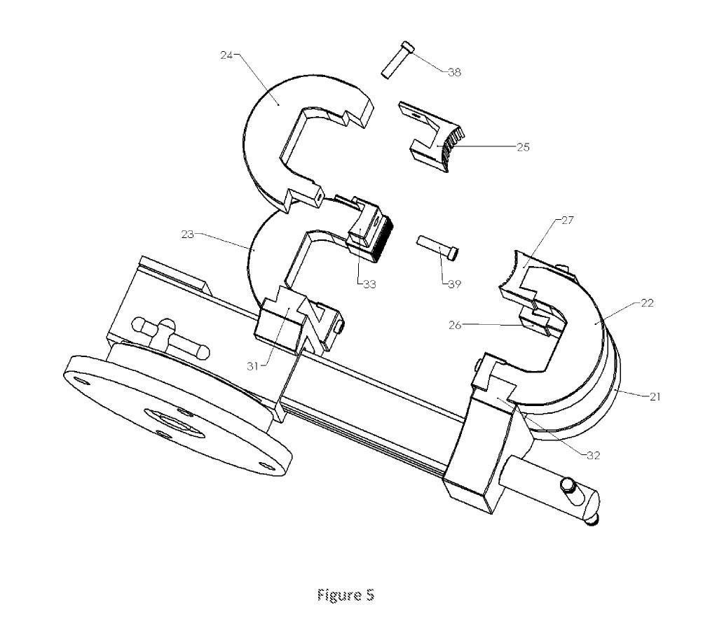

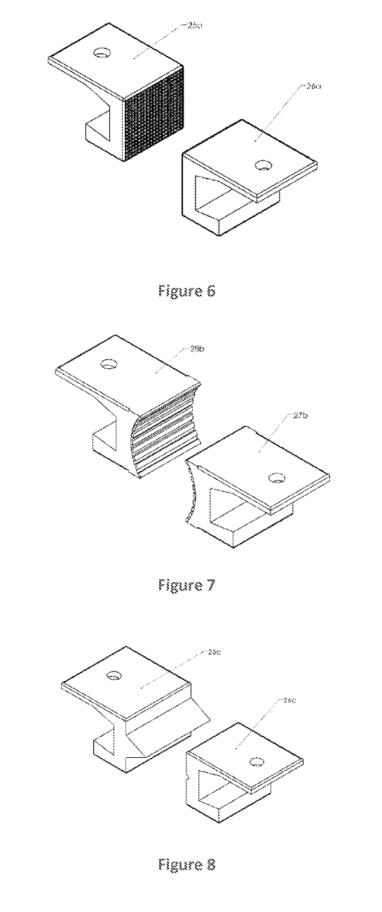

A number of heads are illustrated in FIGS. 6-9. In FIG. 6 are standard heads, 25a to 28a, FIG. 7 illustrates pipe heads, 25b-28b, FIG. 8 shows heads, 25c-28c, for cutting tools that can be used to cut bar stock, sheet metal and the like and FIG. 8 are forming Jaw heads, 25d-28d, for forming sheet metal—formed at round the curved head 28d.

The clamping arms will slide upon a forward and back sliding machined support, 31 and 32.

The main body of the vise can also serve as a striking surface or anvil for work pieces. Other options for the main body include drilling and tapping one side of the base and then connecting via a thread, with the other side open.

The base 12 and 14 may be a swivel base that allows the mounting members to be rotated around the base. The base may also be fixed (not capable of swivel) for mounting on a bench or vehicle bed or it may be configured to allow it to be removably clamped to a table (a familiar design for smaller vise bases). Vises are frequently used with electric systems or in uses where the vise may conduct electricity to ground. It is therefore another aspect of the invention is to construct the base (or the entire vise) of an electrically insulating material. Thus, the base may be made of a non-conducting material such as a polymer material or hard rubber. It may also be constructed with layers of insulating material and steel to provide strength. [0023] The vise may be of any suitable size—small, 1-6 inches total length for hobby use and the like—larger for table and bench vises and even larger and sturdy for heavy duty use such as for mounting on vehicles for field use, plumbing work and the like. The designs disclosed will work well in these sizes and uses.

### Clamping Arms

Clamping arms as used herein is often referred to as the jaws of the vise. The clamping arms (21, 22, 23 and 24 in the Figures) in a C shape configuration are unique in that they allow for more open depth beneath the clamping heads. Traditional vises do not have this open depth, which makes clamping of awkwardly shaped pieces a struggle. This open depth C shape is a preferred feature of the vise of the invention but not a required feature for functionality. The clamping arms (jaws) may therefore, in other embodiments, be made without the open work area, more like the clamping arms of a conventional vise. A conventional vise has the clamping arms perpendicular to the vise base or in line with the clamping heads, with little to no room for an awkward shaped work piece. An optional clamping arm shapes include an I-shape, a triangular shape, a half-moon shape, or any other shape that allow for a large cavity opening below the clamping head. Other arm configurations include a more pronounced U-shape, an elongated V-shape that comes farther away from the work piece. A W-shape that actually captures the work piece in two different positions has advantages.

The bi-directional clamping arms (facing each other as in conventional vises and spreadable along the clamp arm supports) are wide enough to allow ample surface area for small and medium sized work pieces, but could be widened for larger vises and narrowed for smaller ones. The clamping arms are preferably separate individual arms but may be connected to each other (on a single support) so that they move together as a unit.

The arms are designed to enable them to absorb an impact from side to side, such as hammer or other device striking the work piece being held.

In another embodiment there is a slot and locking bar configuration, where there are slots (notches) in the v-shaped glide, 32 of the mount and a locking bar, or multiple locking bars that can be lifted or slid front to back into the slots thereby locking the side to side movement of the clamping arms. In another embodiment the locking mechanism is screwed into a threaded hole, using a set screw (such as an Allen screw) and dove-tail to lock into place.

Another embodiment for locking the arms is a rotational cam that can be turned and then caught in a stable joint, thereby locking the clamping arms or a threaded stud on clamping head and tapped insert on clamping arm to screw the two together.

In another aspect the clamping arm is loosened and tightened on the support by a screw (39), that grabs onto a fixed object of the clamping arms, basically a claw clamping 33, 34) onto a static device, but secure enough that the claw cannot be moved side to side.

The clamping arms will, in one embodiment, have a locking base and quick-action button or trigger for moving the arms side to side along the arm supports. The locking base will be a positive lock and will allow for zero to very minimal movement when set in position.

The material of the clamping arms will preferably be mild to high-tensile steel although other metal and polymer material will be suitable for specific applications. The preferred material will be a high tensile tool steel; however the clamping arms and heads can be made from plastic, nylon, composites, steel alloy, aluminum alloys, ductile iron, or cast products. Engineered plastics such as these currently used in metal replacement application including nylon or polyamide (PA), polybutylene terephthalate (PBT), acetal or polyoxymethylene (POM), polyphenylene sulfide (PPS), polyarylamide (PARA), polyphthalamide (PPA), and polyetheretherketone (PEEK). “The mechanical performance of these polymers, which offer intrinsically high tensile strength and flex modulus, can be significantly extended when the materials are reinforced with compounds such as glass fiber.” Jeff Mccoy; High-Performance Plastics Drive Metal Replacement; available at http://digital.bnpmedia.com/display article.php?id=577068

### Clamping Heads

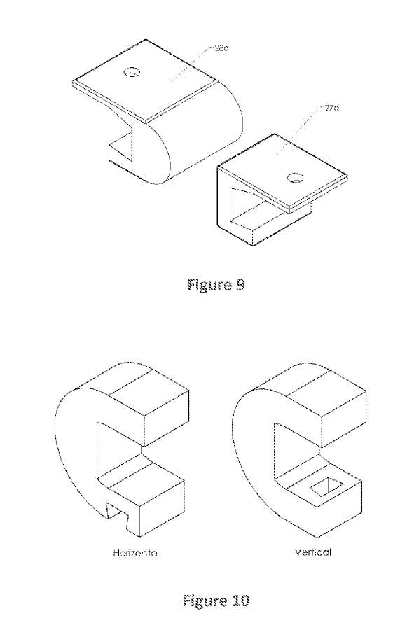

The optional but preferred movable and/or interchangeable clamping heads is the work horse and a key feature of embodiments of the vise of the invention. The clamping heads hold work pieces statically (or dynamically) to allow work to be performed on a work piece. A unique feature of this invention is the ability to quickly swap and interchange these heads to do a variety of different tasks. The ability of the clamping arms to accommodate interchangeable clamping heads configured into a full-range of attachments provides versatility and enhanced utility not available in conventional vises. For example, the heads can be configured for doing different tasks, including in addition to conventional clamping head (such as those illustrated in FIGS. 3-9):
1) A smooth rounded head for sheet metal bending, (FIG. 9);
2) A tube bending die that could be used in conjunction with the bi-directional heads to bend and shape pipe;
3) A series of angled heads, or a swivel head, for holding pieces that have opposing surfaces that are not parallel; and
4) A cutting or shearing attachment used for shearing steel and small bolts (FIG. 7).

Many other heads can be added to the device. Heads would be held in place with a precision dove tail shaped locking pattern or other preferred shape and set screw that can be easily and quickly changed.

Another option is a vertical dovetail or cutout shape that allows the vise heads to come in from the top of the apparatus instead of from the side, this would again be secured by a threaded screw or some type of locking pin. This is useful if in use side impact was expected to move the heads. See FIG. 10 as embodiments of a top attachment. The heads will be attached to the vise by a type of removable sliding notch, or the heads will be detached by tightening and loosening a clamp. The top notch or attachment point will be used to attach the clamping heads to the clamping arm. The bottom notch will be used to attach the clamping arm to the clamping body of the vise. It is important that this notch is free moving allowing the clamping arms to be easily adjusted. The preferred embodiment is that the clamping arms and clamping heads share the same sliding and locking design. The preferred embodiment is that the clamping arms can be quickly and easily removed and re-attached with little effort.

The clamping head will preferably have a locking apparatus and quick-action button or trigger for moving the head on and off the clamping arms. The locking apparatus will be a positive lock and will allow for zero to very minimal movement when set in position. Other options for attaching the clamping head to the clamping arm include a threaded hole on the clamping arm that the vise head then screws into via a threaded stud permanently affixed to the vise head.

The bi-directional clamping arm and/or clamping head in another embodiment could be made by having a spur gear on rack design that offers precise adjustment but can take the beating of field and other off-road applications. This design is similar to and proven rugged by rack style steering in automobiles. Bi-directional means the vise head (clamping head) would be sectioned into 3 or 4 pieces, each able to move both left/right and forward/back. A significant advantage of the vise of this invention is in use for cutting material—in a conventional vise design the clamped material has to be cantilevered off the side of the clamping head and cut in an unstable condition, the sectioned head allows for cutting right in the center while being clamped on both sides. The vise of the invention allows room for better clamping of odd shaped parts.

In one embodiment it is preferred that the body of the vise be machined rather than cast (as are some conventional less expensive vises). The machined vise will use tool steel vs. traditional vises cast parts, and then machined to offer better quality (tighter tolerances) while the same “strength” as cast parts. Another key benefit would be parts can be made in a smaller volume compared to cast parts that have to be made in a foundry, so unsold inventory can be kept to a minimum.

One embodiment is the dove-tail notch or V-notch which allows the vise head to slide side to side and then be fastened by a set screw or other type of screw. See clamp 33, 35 and 34 of FIG. 1 and screws 39. [0038] Other embodiments include:
1.) a gear and track design, where the gear is locked into place along the track to produce a locked clamping arm.
2.) a design similar to a crescent wrench, a helical splined shaft will ride upon a bar with notches matching the location of the helical splines. This will allow the clamping arms to be adjusted along the shaft but still hold a tight grip.
3.) a rod and linear bearing design that features a friction brake. The clamping arms would slide upon the linear shaft and a positive lock/unlock brake would hold into place.
4.) another shape that allows easy sliding. Possible shapes include a round or oval shape, a square shape, a triangular shape similar to the dove-tail but sharper corners.

### Stationary Mounting Base & Movable Mounting Base

The mounting base is the portion between the vise mounting members and the clamping arms. It is made up of 2-block pieces with dove-tail wedges for sliding clamping arms on. The V-shaped cutout (32 in FIG. 2) is the preferred embodiment, but could be replaced by a linear shaft, an acme screw and threaded collar design, a cutout of some other shape. The clamping arms could also be detachable and completely lift away from the vise structure. This could be done by clamping jaws that grab on to a rail, or a wing screw tightening a stop that then positively locks the clamping arm.

The mounting base has two members, one is the portion of the vise that moves forward/backwards to tighten the work piece and the other is stationary and is permanently attached to the vise base. The preferred embodiment will be to tighten/loosen via an acme screw and acme thread in the mounting base. This side will also hold the acme screw into place and allow it to be pulled upon without coming out of the base. The front mounting base will be locked into the vise base by a lower dove-tail shaped notch that will then ride upon the vise bases dove-tail shaped notch or as in some conventional vises that has a cup at one end with a tab, then an outer pipe on the other.

The material of the mounting base can be mild to high-tensile steel. The preferred material will be a high tensile tool steel; however the clamping arms can be made from engineered plastic, nylon, composites, steel alloy, aluminum alloys, ductile iron, or cast products.

In the foregoing specification, the invention has been described with reference to specific embodiments thereof. It will, however, be evident that various modifications and changes can be made thereto without departing from the broader spirit and scope of the invention as set forth in the appended claims. The specification is, accordingly, to be regarded in an illustrative rather than a restrictive sense. Therefore, the scope of the invention should be limited only by the appended claims.

1. A vise having a base on which is attached a fixed mounting member and a movable mounting member, having attached thereon clamping arm supports that are positioned perpendicular to the movement of the movable mounting member and having at least two clamping arm on at least one mounting support and means for attaching, removing and moving the mounting members toward and away from each other.

2. The vise of claim 1 wherein each of the clamping arms is movably and removably attached to a clamping arm support that is attached to a mounting member.

3. The vise of claim 1 wherein there are at least two clamping arms on each of the clamping arm supports.

4. The vise of claim 1 wherein each of the clamping arms have replaceable head(s).

5. The vise of claim 4 wherein the removable heads are selected from the group consisting of:
Standard vise heads; pipe heads; cutting tool heads; jaw heads and curved heads.

6. The vise of claim 1 wherein the base is selected form the group consisting of, fixed, swivel, bench mount and clamp table mount.

7. The vise of claim 1 wherein at least two of the clamping arms are connected together so as to move as a single unit.

8. The vise of claim 1 wherein the clamping arms are configured into as shapes selected from the group consisting of: C shaped; I-shape, a triangular shape; half-moon shape; U-shape, elongated V-shape; W-shape or other shape that allows for a large cavity opening below the clamping head.

9. The vise of claim 1 wherein the clamping arms are configured into a C shape.

10. The vise of claim 1 wherein the clamping arm heads are configured as standard flat heads, butting heads, pipe clamping heads, cutting heads, special application tool heads or metal forming heads.

11. The vise of claim 1 wherein the clamping head have a locking apparatus and quick-action button or trigger for moving the head on and off the clamping arms.

12. The vise of claim 11 wherein the locking mechanism comprises a threaded hole on the clamping arm that the vise head then screws into via a threaded stud permanently affixed to the vise head.

14. The vise of claim 1 wherein the clamping arms are open vertically to the plane of the base.

15. The vise of claim 1 wherein the base is comprised of electrically insulating material to prevent an electrical circuit.

16. The vise of claim 1 constructed of tool steel and machined into the desired shape.
